(19) United States
(12) Patent Application Publication
(10) Pub. No.: US 2026/0245424 A1
(43) Pub. Date: Aug. 20, 2026

(54) LIGHTING MODULES WITH MULTIPLE PARALLEL OPTICALLY TRANSMISSIVE FINS

(71) Applicant: Aristocrat Technologies, Inc., Las Vegas, NV (US)

(72) Inventors: Timothy Barbour, Nolensville, TN (US); Xiaoqiang Gong, Henderson, NV (US); Rajendrasinh Jadeja, Las Vegas, NV (US); Charles Miller, SR., Henderson, NV (US); Stephen Shaffer, JR., Las Vegas, NV (US); Donald Rodd, Palm Beach Garden, FL (US)

(21) Appl. No.: 19/056,618

(22) Filed: Feb. 18, 2025

(51) Int. Cl. G07F 17/32

(52) U.S. Cl. CPC G07F 17/3213; G07F 17/3216; G07F 17/3223

(57) ABSTRACT

Lighting modules with multiple optically transparent fin structures. The optically transparent fin structures may be arranged in a generally parallel manner and may each be illuminated by a corresponding array of light sources such that each optically transparent fin may be individually illuminated.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.” “Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Electronic gaming machines often feature extensive assortments of audiovisual devices that are used during game play, award payout, and during “attract” modes. The present disclosure is directed towards new implementations of lighting modules that may be suitable for use in such electronic gaming machines—although it will be understood that such lighting modules may also be used in any device or system in which the lighting effects produced by such modules may be desired.

### SUMMARY

Details of one or more implementations of the subject matter described in this specification are set forth in the accompanying drawings and the description below. Other features, aspects, and advantages will become apparent from the description, the drawings, and the claims.

In some implementations, an apparatus may be provided that may include a base with a plurality of slots. The base may extend along an elongate path, and the slots may extend along directions aligned with the elongate path. The apparatus may also include a plurality of optically transmissive fins, and a plurality of first arrays of light sources located within the base. Each optically transmissive fin may have a first longitudinal edge surface located within a corresponding one of the slots and a second longitudinal edge surface on an opposite side of that optically transmissive fin from the first longitudinal edge surface thereof. Each optically transmissive fin may also have a pair of side surfaces that face in opposite directions from one another and that each span between the first longitudinal edge surface and the second longitudinal edge surface of that optically transmissive fin. Each optically transmissive fin may extend out of the base, and each first array of light sources may be positioned so as to direct light into the first longitudinal edge surface of one of the optically transmissive fins when the light sources in that first array of light sources are activated.

In some implementations, the base may be made of an optically opaque material, each slot may have one or more first apertures in a bottom surface thereof, and each light source in the plurality of first arrays of light sources may be positioned so as to direct light through one of the first apertures and into the first longitudinal edge surface of one of the optically transmissive fins when that light source is activated.

In some implementations, the second longitudinal edge surfaces of at least two of the optically transmissive fins may have non-linear, cyclic profiles.

In some implementations, the non-linear, cyclic profiles may be phase-shifted relative to each other.

In some implementations, the slots may follow parallel paths.

In some implementations, the paths may be non-linear.

In some implementations, at least one of the optically transmissive fins may have one or more pattern regions in between the first longitudinal edge surface and the second longitudinal edge surface thereof and in between the side surfaces thereof. Each pattern region may have one or more light-reflecting features located therein, and the light-reflecting features within each pattern region may be configured to redirect light directed into the first longitudinal edge surface of the optically transmissive fin having that pattern region and towards the second longitudinal edge surface of the optically transmissive fin having that pattern region such that at least some of the light is emitted from at least one of the side surfaces of the optically transmissive fin having that pattern region.

In some such implementations, each optically transmissive fin may have one or more of the pattern regions.

In some implementations, at least part of the second longitudinal edge surface of at least one of the optically transmissive fins may define one or more acute angles relative to one of the side surfaces of the optically transmissive fin having the second longitudinal edge surface.

In some such implementations, the one or more acute angles may be between 40° and 50°.

In some implementations, the apparatus may further include a controller that is configured to selectively cause the light sources of each of the first arrays of light sources to emit light independently of each of the light sources of the other first arrays of light sources.

In some such implementations, the light sources in each of the first arrays may be configured to be controllable to selectively emit different wavelengths of light in response to different control signals, and the controller may be further configured to cause the light sources of one of the first arrays of light sources to emit light of a first wavelength and the light sources of another of the first arrays of light sources to emit light of a second wavelength different from the first wavelength.

In some implementations, the controller may be further configured to selectively activate the light sources within each first array of light sources such that a maximum intensity of light emitted from the light sources within that first array of light sources or light emitted from the light sources within that first array of light sources and of a particular wavelength moves along a length of one of the optically transparent fins.

In some implementations, the apparatus may include a second array of light sources located within the base. The apparatus may also include a plurality of optically transmissive windows. The base may have a plurality of second apertures, each optically transmissive window may be positioned so as to cover or extend into a corresponding one of the second apertures, and the light sources in the second array of light sources may be positioned so as to emit light towards the second apertures when caused to emit light.

In some implementations, there may be four optically transmissive fins.

In some implementations, the optically transmissive fins may all at least partially overlap one other when viewed along a first axis perpendicular to one of the side surfaces.

In some implementations, the second longitudinal edge surfaces of at least two of the optically transmissive fins may cross over one another at multiple first locations when viewed along the first axis and may not cross over one another at second locations in between the first locations when viewed along the first axis.

In some implementations, the apparatus may further include an electronic gaming machine cabinet and the base may extend along at least one edge of the electronic gaming machine cabinet.

These and other implementations are discussed below with respect to the drawings.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an example lighting module.

FIGS. 5 and 6 depict exploded views of the lighting module of FIG. 4.

FIG. 7 depicts a side view of the lighting module of FIG. 4 with a section line showing a sectioning plane for FIGS. 8 and 9.

FIGS. 8 and 10 depict section views of the lighting module of FIG. 4 along the section line shown in FIG. 7.

FIG. 11 depicts the lighting module of FIG. 4 in various states of illumination.

FIGS. 12 and 13 depict lighting modules installed on an electronic gaming machine.

The Figures are provided for the purpose of providing examples and clarity regarding various aspects of this disclosure and are not intended to be limiting.

### DETAILED DESCRIPTION

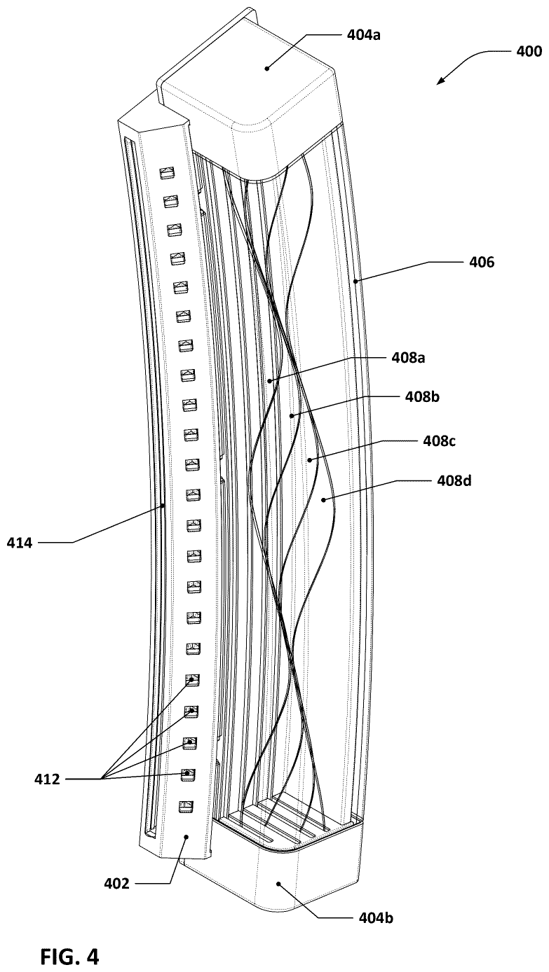

The following discussion provides overall context for electronic gaming machines, some of which may include lighting modules such as those discussed later herein with respect to FIG. 4 onwards.

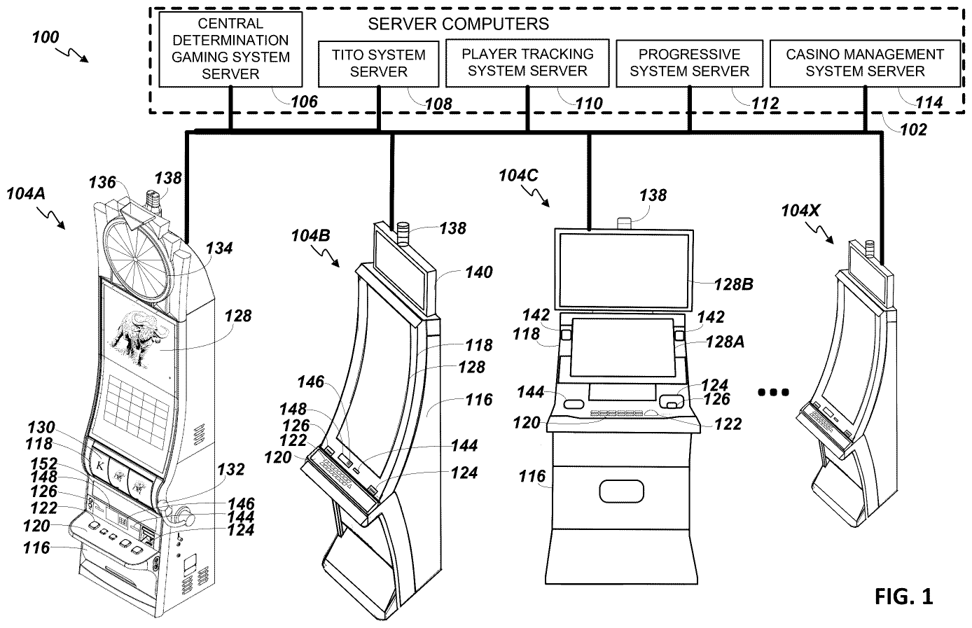

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

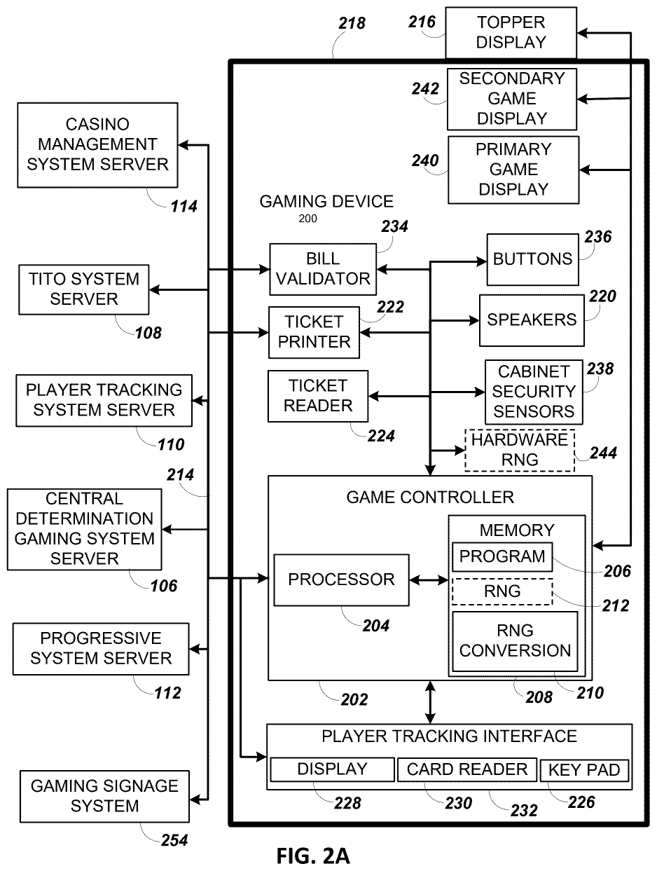

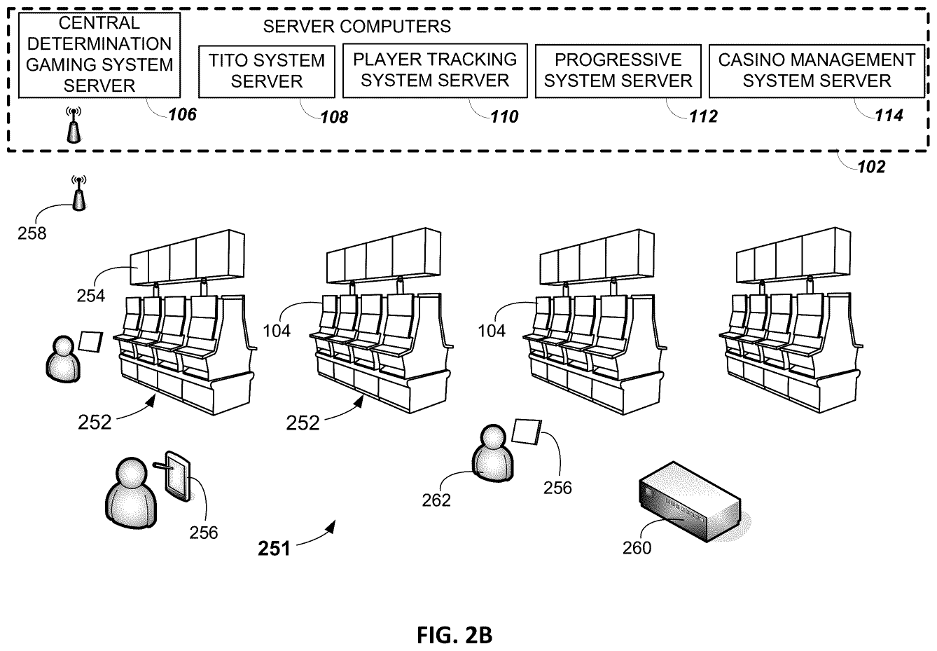

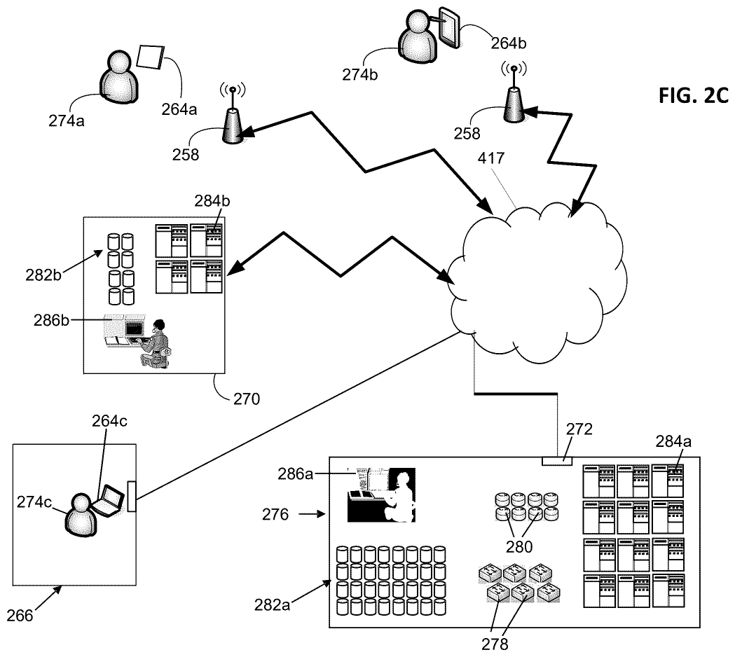

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

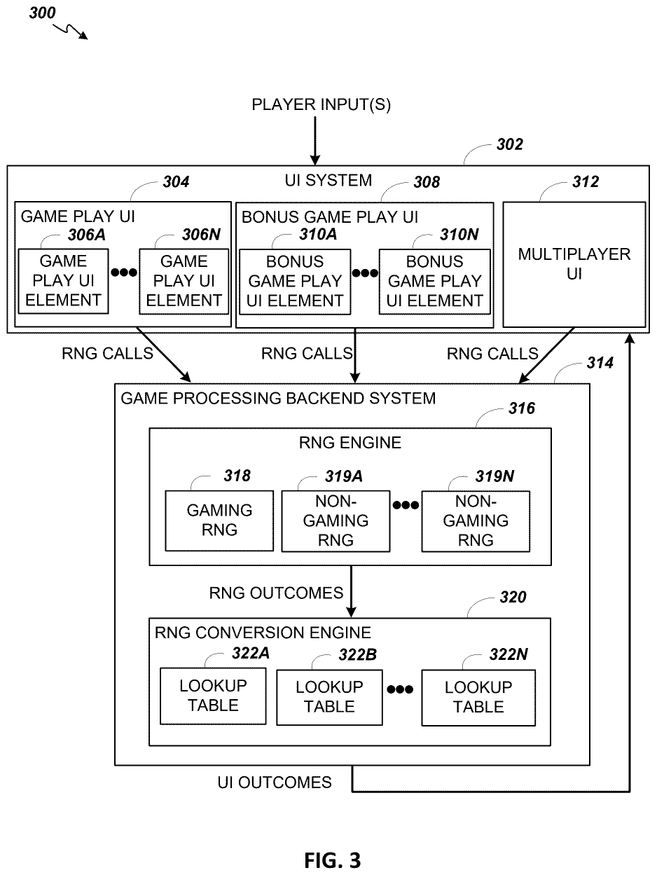

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As discussed earlier, electronic gaming machines may incorporate a wide variety of audiovisual devices, e.g., speakers, displays, lighting devices, etc. As electronic gaming machines continue to grow in physical size and/or complexity, the number of such audiovisual devices, and their power needs, have tended to increase. It is not uncommon for modern electronic gaming machines to draw 500 or 600 watts (or more) during operation. Taking into account that a given casino may operate hundreds or thousands of electronic gaming machines on a continuous basis, the amount of electrical power that such a casino may need to pay for in order to keep the electronic gaming machines ready for play may cost hundreds of thousands of dollars per year.

Disclosed herein are lighting modules that may be used in electronic gaming machines or similar equipment in order to present lighting effects in a more energy-efficient manner. The lighting modules may incorporate a plurality of light sources, e.g., light-emitting diodes (LEDs), arranged in arrays, a base, and a plurality of optically transmissive fins. The base may support the light sources and the optically transmissive fins such that each array of light sources illuminates one of the optically transmissive fins. Such lighting modules may provide a layered lighting effect in which each layer of lighting may be individually controlled with respect to brightness, color, and/or on/off state. Moreover, the light sources used to illuminate each layer may also be individually controllable with respect to brightness, color, and/or on/off state. Such configurations may allow such multi-layer lighting modules to display various illumination patterns and effects that may be attractive to nearby individuals and thus draw people towards, for example, a gaming machine having such lighting modules.

FIG. 4 depicts an example lighting module that may, for example, be used in a gaming machine cabinet or similar device to produce lighting effects that may be used in a coordinated audiovisual display that may be provided as part of a game presentation or in an attract mode for the electronic gaming machine. The lighting module 400 in this example is fairly short, e.g., ~18″ long, in order to allow it to be seen in its entirety on the page but it will be understood that such lighting modules may be manufactured to be any desired length, e.g., long enough to extend along the length and/or width of a display or displays of an EGM.

The lighting module 400 in this example is curved, e.g., in a concave manner, but it will be understood that the lighting module 400 may be curved in a convex manner, straight, or may follow a compound path, e.g., convex for a portion and concave for another portion.

The lighting module 400 may, for example, include a base 402 that may serve to contain light sources that may be used to illuminate a plurality of optically transmissive fins 408. The base 402 may generally be made of an optically opaque material such that light from light sources in the base 402 is not visible except through apertures in the base 402. In this example, there are four optically transmissive fins 408a, 408b, 408c, and 408d, but other implementations may have a lesser number of optically transmissive fins 408, e.g., two or three optically transmissive fins 408, or more optically transmissive fins 408, e.g., five, six, etc. optically transmissive fins 408.

Each optically transmissive fin 408 may be made of an optically transmissive material, such as clear acrylic, polycarbonate, polyvinylchloride, etc., and the optically transmissive fins 408 may be arranged in a side-by-side fashion such that they follow generally parallel paths. It will be understood that for lighting modules 400 in which the optically transmissive fins 408 follow a non-linear path from one end of the lighting module 400 to the other end thereof, the spacing between adjacent optically transmissive fins 408 in a direction perpendicular to the paths may remain constant along the lengths of the optically transmissive fins 408, i.e., the optically transmissive fins 408 may follow non-linear paths that are parallel to one another along their lengths.

In some implementations, the optically transmissive fins 408 may be covered by an optically transmissive cover 406. While optional, the optically transmissive cover 406 may protect the optically transmissive fins 408 from dust, airborne particulates, fingerprints, etc. In particular, due to the parallel arrangements of the optically transmissive fins 408, dust that collects on the side surfaces of the optically transmissive fins may be difficult to clean. The optically transmissive cover 406 may provide a barrier against such potential contaminants.

The base 402 in this example also includes additional lighting structures, e.g., a strip of optically transmissive windows 412 that are arranged along the bottom of the base 402, as well as a strip light 414 that extends along the length of the base 402. The additional lighting structures may be optional and either or both types of such additional lighting structures may be included, if desired.

The ends of the lighting module 400 may be capped by end caps 404a and 404b.

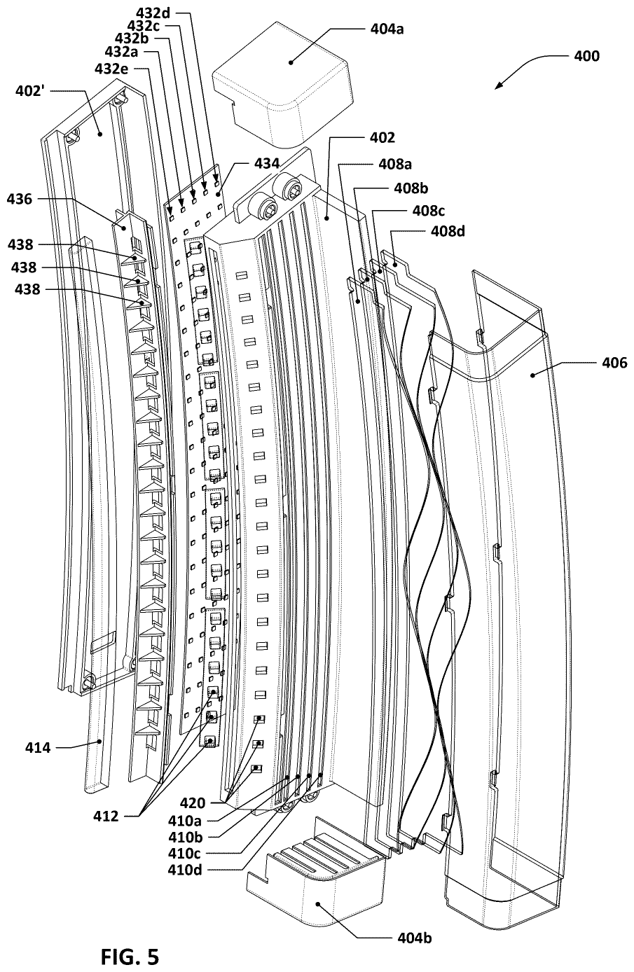

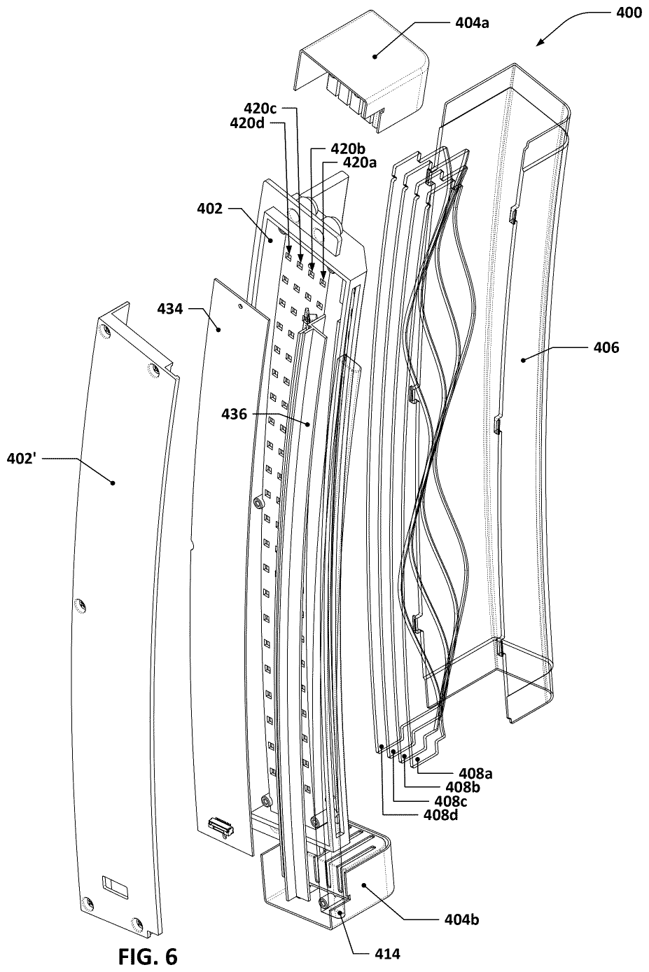

FIGS. 5 and 6 depict exploded views of the lighting module 400. As can be seen, the four optically transmissive fins 408 can be inserted into slots 410, e.g., optically transmissive fin 408a may be inserted into slot 410a, optically transmissive fin 408b may be inserted into slot 410b, optically transmissive fin 408c may be inserted into slot 410c, and optically transmissive fin 408d may be inserted into slot 410d. The base 402 may have a lid 402′ that may cap an interior cavity of the base 402 that may contain a substrate, such as printed circuit board (PCB) 434, that has a plurality of light sources 432 mounted to it. The light sources 432 may, for example, be arranged in arrays along paths that follow the paths that the optically transmissive fins 408 and the slots 410 that the optically transmissive fins 408 are inserted in follow. It will be noted that in the example of FIGS. 5 and 6, the PCT 434 has five sets of light sources 432, with four of the sets of light sources 432 each being arranged along a curving path that follows the path taken by one of the optically transmissive fins 408. The fifth set of light sources 432 follows a similar path, but is located along the edge of the PCB 434 such that light from each such light source 432 is able to shine through a corresponding opening in a shield 436 and towards one of the optically transmissive windows 412. In some instances, the shield 436 may include partitions 438 in between each pair of adjacent openings in the shield. The partitions 438 may, for example, allow each light source 432 along the edge of the PCB 434 to illuminate the corresponding optically transmissive window 412 with little or no light from the light source 432 bleeding through into the neighboring optically transmissive window(s) 412. The shield 436 may also include a wall that may extend along the back edges of the partitions 438 and serve to block or occlude the light emitted from the light sources 432 from reaching the strip light 414. The strip light 414 may, for example, be a flexible strip of material that has light sources embedded within it that can be individually controlled, e.g., to produce a light-chasing, light pulsing, or other effect. The wall may be interposed between the strip light 414 and the openings in the shield 436.

The base 402 may have corresponding pluralities of first apertures 418 arranged along the bottom surfaces 410 to allow light from the light sources 432 positioned underneath the slots 410 to shine into the underside of the optically transmissive fins 408. The base 402, in this example, also has a plurality of second apertures 420 that may correspondingly allow light from the edge-mounted light-sources 432 to shine through the optically transmissive windows 412. Each optically transmissive window 412 may be positioned so as to cover or extend into one of the second apertures 420.

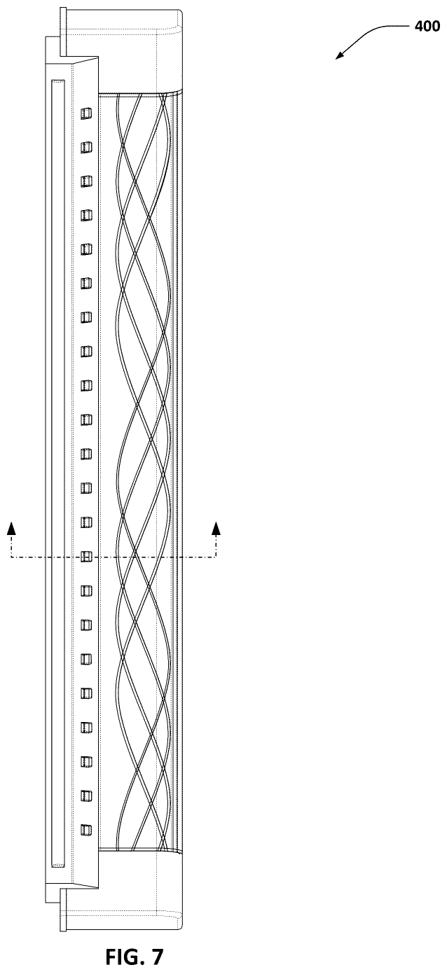

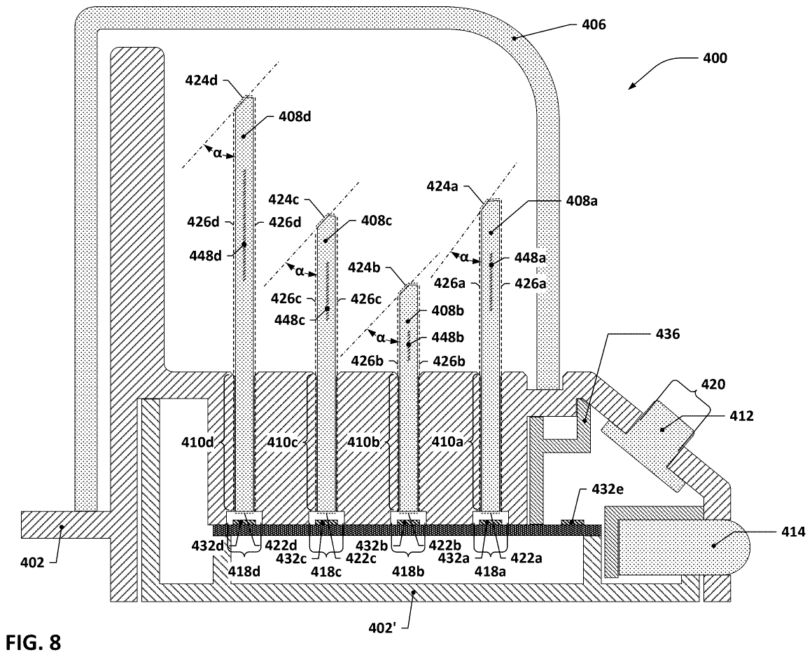

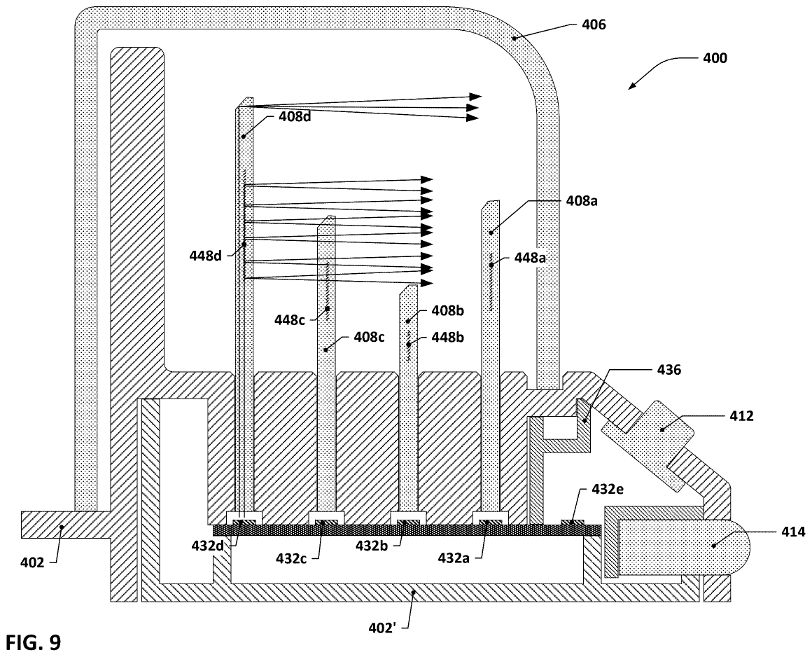

FIG. 7 depicts a side view of the lighting module 400 with a section line showing a sectioning plane for FIGS. 8 and 9. FIG. 9 is the same as FIG. 8 except that it shows some example light rays emitted by the light sources 432d and how such light rays may be reflected by various elements of the optically transmissive fin 408d.

As can be seen in FIG. 8, each optically transmissive fin 408 may have a cross-sectional profile that defines a first longitudinal edge surface 422 that is inserted into one of the slots 410 and a second longitudinal edge surface 424 on an opposite side of the optically transmissive fin 408 from the first longitudinal edge surface 422. Each optically transmissive fin 408 may extend out of the base 402 and may also have corresponding side surfaces 426 that each span between the first longitudinal edge surface 422 and the second longitudinal edge surface 424 and that face in opposite directions from one another. For example, the optically transmissive fin 408a may have a first longitudinal edge surface 422a and a second longitudinal edge surface 424a and side surfaces 426a spanning between the first longitudinal edge surface 422a and the second longitudinal edge surface 424a, the optically transmissive fin 408b may have a first longitudinal edge surface 422b and a second longitudinal edge surface 424b and side surfaces 426b spanning between the first longitudinal edge surface 422b and the second longitudinal edge surface 424b, the optically transmissive fin 408c may have a first longitudinal edge surface 422c and a second longitudinal edge surface 424c and side surfaces 426c spanning between the first longitudinal edge surface 422c and the second longitudinal edge surface 424c, and the optically transmissive fin 408d may have a first longitudinal edge surface 422d and a second longitudinal edge surface 424d and side surfaces 426d spanning between the first longitudinal edge surface 422d and the second longitudinal edge surface 424d.

As can be seen from FIG. 8, in some instances, the walls of the base 402 defining the slots 410 may extend all the way down to the PCB 434, thereby each set of light sources 432a, 432b, 432c, and 432d from the neighboring set(s) of light sources 432a, 432b, 432c, or 432d. Each of the light sources 432a, 432b, 432c, and 432d is positioned within one of the first apertures 418a, 418b, 418c, or 418d such that light emitted from the light sources 432a, 432b, 432c, and 432d, when powered, may be directed into one of the first longitudinal edge surfaces 422a, 422b, 422c, or 422d, respectively.

One or more of the second longitudinal edge surfaces 424a, 424b, 424c, and 424d may have a beveled edge along one of the longer edges defining that second longitudinal edge surface 424 such that at least part of that second longitudinal edge surface 424 defines one or more acute angles (α) relative to one of the side surfaces of the optically transmissive fin 408 having that second longitudinal edge surface 424. In the depicted example, all of the optically transmissive fins 408 have such a beveled edge. The angle α, in some implementations, may be between 40° and 50°, although other angles may be used depending on the particular configuration that is desired. In some implementations in which multiple optically transmissive fins 408 have the beveled edge, the beveled edge may be located on the same sides of the optically transmissive fins 408, as shown in FIGS. 8 and 9. The angled portions of the second longitudinal edge surface(s) 424 may, in some instances, be treated in order to increase their diffusivity and/or reflectance. For example, such surfaces may be etched, frosted, coated, or otherwise treated in order to increase reflectivity and/or diffusivity.

In some implementations, one or more of the optically transmissive fins 408 may also incorporate light-reflecting features 448 within the interior of such optically transmissive fins 408. Such light-reflecting features 448 may, for example, be made through laser etching and may take the form of prisms or prismatic reflectors that are etched into the interior of the optically transmissive fins 408. Such light-reflecting features 448 may be referred to as “see-through panels” (STPs). The light-reflecting features 448 may generally be invisible or nearly invisible to nearby observers looking through the optically transmissive fin 408 through one of the side surfaces 426 thereof until illuminated by light transmitted into the optically transmissive fin 408 along a particular edge, e.g., via the corresponding first longitudinal edge surface 422. The majority of the light that is emitted into the optically transmissive fin 408 along the first longitudinal edge surface 422 will generally reflect off of the side walls 426 due to being incident on the side walls 426 at a relatively shallow angle. However, the light that is directed into the optically transmissive fin 408 and that reaches the light-reflecting features 448 or the angled portion of the second longitudinal edge surface 424 may be caused to change direction so as to travel in a direction generally outward from one of the side surfaces 426 of the optically transmissive fin 408, as shown, for example, for optically transmissive fin 408d in FIG. 9 (as indicated by the arrows/lines radiating out from the light source 432d up into the optically transmissive fin 408d and then being reflected out to the right by the light-reflecting features 448 and the angled portion of the second longitudinal edge surface 424d. The other optically transmissive fins 408 may be similarly configured.

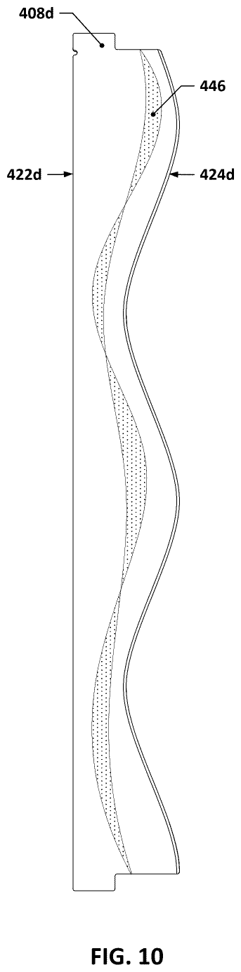

The light-reflecting features 448 may each be individually quite small, e.g., microscopic, and may be of varying sizes so as to individually reflect more or less light. Such light-reflecting features 448 may, for example, be implemented in a manner similar to how pixels or half-tone dots are arranged in order to produce a desired graphical image. FIG. 10 depicts a side view of one of the optically transmissive fins 408, in this example, optically transmissive fin 408d. As can be seen in FIG. 10, the optically transmissive fin 408d has a pattern region 446 that takes the shape of an undulating, twisting ribbon. The light-reflecting features 448 for the optically transmissive fin 408d may be distributed throughout the pattern region 446 such that the pattern region 446 illuminates when light from the light sources 432d is directed into the first longitudinal edge surface 422d. While not explicitly shown, each optically transmissive fin 408 may have its own pattern region 446 with light-reflecting features in it that illuminate when light from the respective light sources 432 for that optically transmissive fin 408 is directed into the first longitudinal edge surface 422 of that optically transmissive fin 408. In some implementations, there may be multiple, discrete pattern regions 446 for a given optically transmissive fin 408. The light-reflecting features 448 within each pattern region 446 may each individually be configured to redirect light directed into the first longitudinal edge surface 422 of the optically transmissive fin 408 having that pattern region 446 and towards the second longitudinal edge surface 424 of the optically transmissive fin 408 having that pattern region 446 such that at least some of the light is emitted from at least one of the side surfaces 426 of the optically transmissive fin 408 having that pattern region 446. The pattern regions 446/light-reflecting features 448 may generally be located within the optically transmissive fins 408, e.g., in between the first longitudinal edge surface 422 and the second longitudinal edge surface 424, as well as in between the side surfaces 426, of each respective optically transmissive fin 408.

In the example lighting module 400, the individual optically transmissive fins 408 have generally the same profile for the second longitudinal edge surfaces 424, with each such second longitudinal edge surface 424 describing a generally non-linear, cyclic profile when viewed along a direction perpendicular to the side surfaces 426 of the optically transmissive fin 408 having that second longitudinal edge surface 424. In this case, such profiles are generally sinusoidal in nature, although other profiles may be used as well. The profiles described by the second longitudinal edge surfaces 424 in the depicted example are staggered or phase-shifted relative to one another, e.g., along the lengths of the optically transmissive fins 408, such that the “high points” of the second longitudinal edge surface 424 profiles are spaced apart from one another, when viewed along a direction perpendicular to the side surfaces 426, by the same distance or by multiples of the same distance. As such, each of the optically transmissive fins 408 at least partially overlaps at least one of the other optically transmissive fins 408 when viewed along an axis perpendicular to one of the side surfaces 426. In the depicted implementations, the second longitudinal edge surfaces 424 may, when viewed along the axis perpendicular to one of the side surfaces 426, cross over one another at multiple first locations and may not cross over one another at multiple second locations in between the first locations, similar to how multiple helical paths or braided strands may cross over each other along the length of the helix or braided strands. Such an arrangement may give the illusion of a complex, helical arrangement of light filaments, but using a much simpler arrangement of components.

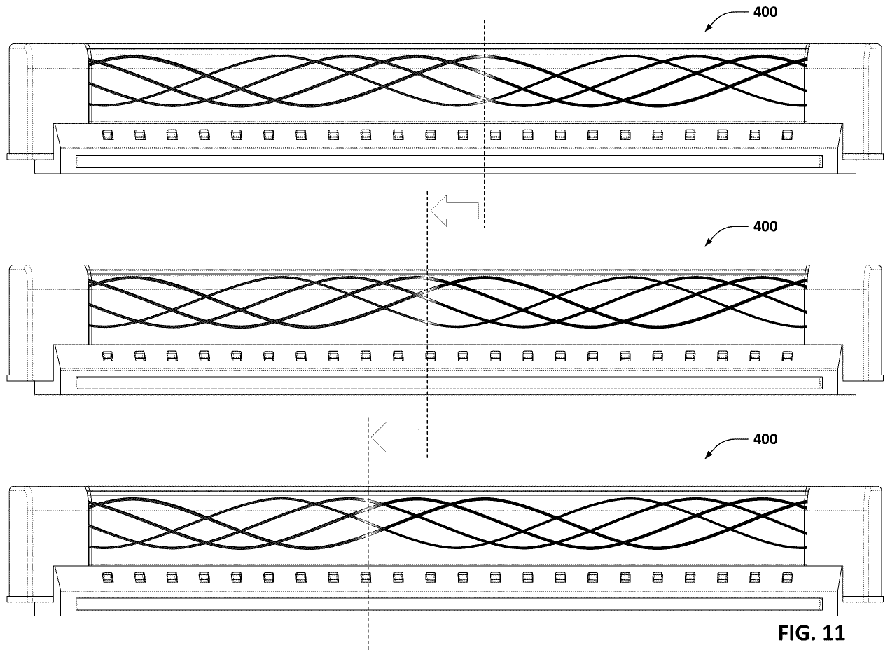

As discussed earlier, the various light sources 432 that may be used may, in some instances, be individually controllable, both within a particular array of light sources and between arrays of light sources. For example, each light source 432 may, in some cases, be individually controllable, e.g., like a pixel in an array of pixels. In such implementations, various lighting effects may be implemented by connecting such light sources 432 to a controller that may selectively activate the light sources 432 so as to produce particular graphical effects. For example, one effect that may be implemented by the controller is illustrated in FIG. 11, which depicts the lighting module 400 in three different lighting states. The second longitudinal edge surfaces 424 are shown in black to represent when they are not caused to be illuminated by the light sources 432; the region of each second longitudinal edge surface 424 that is shown in white (and indicated by the dashed transverse lines across each lighting module 400) represents a region of such surfaces that is caused to emit light by causing the corresponding light source 432 at that location to illuminate. The pattern regions 446, in this example, are not depicted to avoid undue clutter. By having the controller control the light sources 432 such that each array of light sources 432 that provides light to one of the slots 410 sequentially increases the brightness of each light source 432 along the path for that array and then sequentially decreases the brightness of each light source 432 along that path. Such an effect may give the appearance that there is a light emission source that travels from one end of the path for the array of light sources 432 to the other end of the path for the array of light sources 432. In some instances, the light sources 432 that are not at peak brightness within each array of light sources 432 may be completely deactivated so as to be dark, in which case it may appear that a single light source 432 is moving along each path.

In some such implementations, the light sources 432 in each array that provides light to the slots 410 may be sequentially increased/decreased in brightness in a synchronized manner so as to make it appear that a strip of light sources 432 that is transverse to the path(s) followed by the arrays of light sources is advancing along the path(s) in unison. If such an effect is implemented in an arrangement such as the lighting module 400, the resulting optical effect is that it appears that a ring of lights (where the light from the light sources 432 exits the optically transmissive fins 408) is travelling along a path generally along the middle of the second longitudinal surfaces 424 while simultaneously orbiting about that path. If each array of light sources 432 is caused to emit a different color of light, then the effect is that of a ring of multicolored lights spinning while traveling along the path.

In other implementations, the movement of the highest-intensity light emitted by each array of light sources 432 may not be synchronized with the movement of the highest-intensity light emitted by the other arrays of light sources 432, in which case, the lighting module 400 may appear to have lights that chase along different helical paths.

Such a controller may, for example, be configured to control the light sources 432 so as to each be individually controllable so as to selectively emit different wavelengths of light and/or selectively control the intensity of the emitted light (or cause the respective light source 432 to emit no light) in response to different control signals.

The light sources 432 may, for example, be light-emitting diodes (LEDs), such as surface-mount LEDs, and may be either single-color or multi-color, e.g., red-green-blue LED packages that may be controlled so as to emit a combination of different amounts of each of red, blue, and green wavelengths in order to allow any color in a continuous spectrum of colors to be emitted by the LED package.

Lighting modules 400 as discussed herein may be adapted to be used on electronic gaming machines, e.g., to provide accent and/or edge lighting to an electronic gaming machine cabinet. For example, such lighting modules 400 may be extended in length to extend along an edge of a main and/or secondary display of an electronic gaming machine, or along a top edge of such a display, or along another edge of the electronic gaming machine cabinet. In such implementations, lighting effects produced by the lighting module may be caused to be displayed in coordination with events occurring within a game playable on the electronic gaming machine 401 and/or when the electronic gaming machine 401 is not in use by a player, e.g., as part of an attract mode sequence designed to catch the attention of passersby and potentially cause such a passerby to engage in play on the electronic gaming machine.

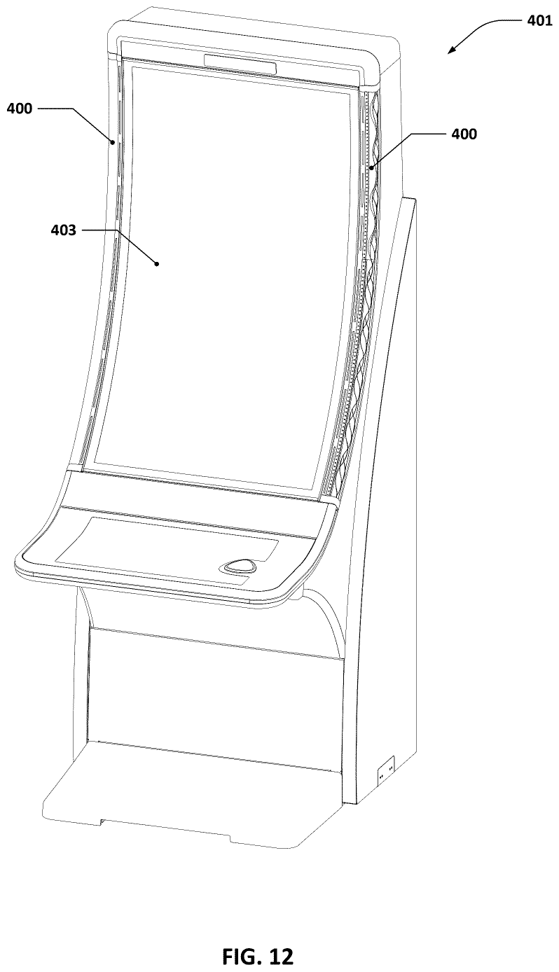

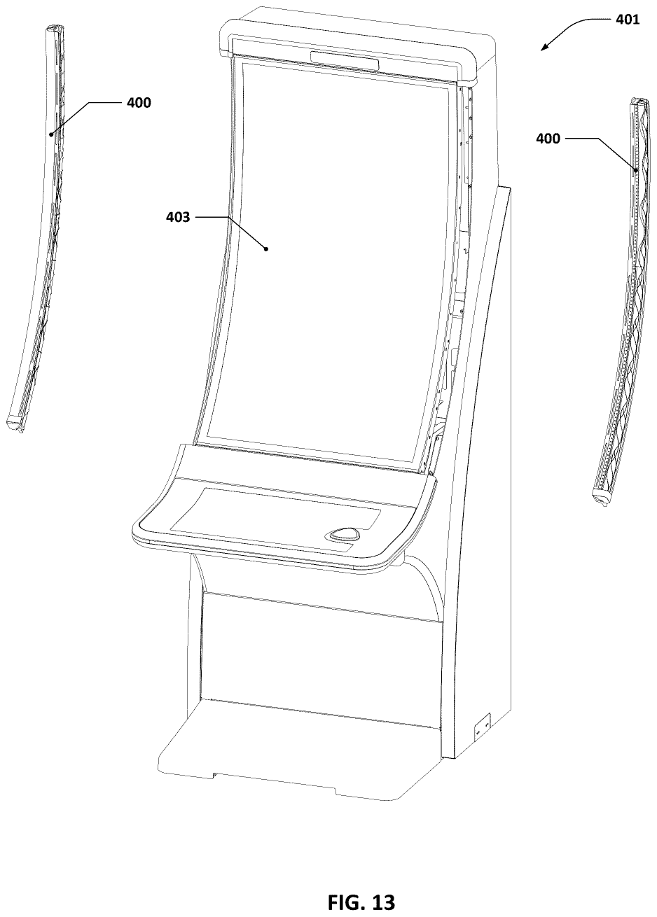

FIG. 12 depicts an example cabinet-based electronic gaming machine 401 that has two lighting modules 400 extending along the sides of a main display 403. FIG. 13 depicts the same cabinet-based electronic gaming machine 401 with the lighting modules 400 removed. The internal details of the left-side lighting module 400 are not depicted in FIGS. 12 and 13, but may be mirror images of the details shown for the lighting module 400 on the right-hand side of the electronic gaming machine 401.

It will be understood that the lighting modules discussed herein may be generally elongate in nature, e.g., having a maximum dimension in one direction and much smaller dimensions along axes orthogonal to that direction or generally following a linear and/or non-linear path that is much longer in length than the dimensions of the lighting module perpendicular to that path. It will be further understood that the slots that receive the optically transmissive fins may generally also extend along elongate paths that are aligned with, e.g., parallel to, the elongate path that the lighting module extends along (as opposed to along paths that are generally transverse to that elongate path.

It is to be understood that the phrases “for each <item>of the one or more <items>,” “each <item>of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An apparatus comprising:
a base with a plurality of slots and extending along an elongate path, wherein the slots extend along directions aligned with the elongate path;
a plurality of optically transmissive fins, wherein:
each optically transmissive fin has a first longitudinal edge surface located within a corresponding one of the slots and a second longitudinal edge surface on an opposite side of that optically transmissive fin from the first longitudinal edge surface thereof,
each optically transmissive fin has a pair of side surfaces that face in opposite directions from one another and that each span between the first longitudinal edge surface and the second longitudinal edge surface of that optically transmissive fin, and
each optically transmissive fin extends out of the base; and
a plurality of first arrays of light sources located within the base, each first array of light sources positioned so as to direct light into the first longitudinal edge surface of one of the optically transmissive fins when the light sources in that first array of light sources are activated.

2. The apparatus of claim 1, wherein:
the base is made of an optically opaque material,
each slot has one or more first apertures in a bottom surface thereof, and
each light source in the plurality of first arrays of light sources is positioned so as to direct light through one of the first apertures and into the first longitudinal edge surface of one of the optically transmissive fins when that light source is activated.

3. The apparatus of claim 1, wherein the second longitudinal edge surfaces of at least two of the optically transmissive fins have non-linear, cyclic profiles.

4. The apparatus of claim 3, wherein the non-linear, cyclic profiles are phase-shifted relative to each other.

5. The apparatus of claim 1, wherein the slots follow parallel paths.

6. The apparatus of claim 5, wherein the paths are non-linear.

7. The apparatus of claim 1, wherein:
at least one of the optically transmissive fins has one or more pattern regions in between the first longitudinal edge surface and the second longitudinal edge surface thereof and in between the side surfaces thereof,
each pattern region has one or more light-reflecting features located therein, and
the light-reflecting features within each pattern region are configured to redirect light directed into the first longitudinal edge surface of the optically transmissive fin having that pattern region and towards the second longitudinal edge surface of the optically transmissive fin having that pattern region such that at least some of the light is emitted from at least one of the side surfaces of the optically transmissive fin having that pattern region.

8. The apparatus of claim 7, wherein each optically transmissive fin has one or more of the pattern regions.

9. The apparatus of claim 1, wherein at least part of the second longitudinal edge surface of at least one of the optically transmissive fins defines one or more acute angles relative to one of the side surfaces of the optically transmissive fin having the second longitudinal edge surface.

10. The apparatus of claim 9, wherein the one or more acute angles are between 40° and 50°.

11. The apparatus of claim 1, further comprising a controller configured to selectively cause the light sources of each of the first arrays of light sources to emit light independently of each of the light sources of the other first arrays of light sources.

12. The apparatus of claim 11, wherein:
the light sources in each of the first arrays are configured to be controllable to selectively emit different wavelengths of light in response to different control signals, and
the controller is further configured to cause the light sources of one of the first arrays of light sources to emit light of a first wavelength and the light sources of another of the first arrays of light sources to emit light of a second wavelength different from the first wavelength.

13. The apparatus of claim 11, wherein the controller is further configured to selectively activate the light sources within each first array of light sources such that a maximum intensity of light emitted from the light sources within that first array of light sources or light emitted from the light sources within that first array of light sources and of a particular wavelength moves along a length of one of the optically transparent fins.

14. The apparatus of claim 1, further comprising:
a second array of light sources located within the base; and
a plurality of optically transmissive windows, wherein:
the base has a plurality of second apertures,
each optically transmissive window is positioned so as to cover or extend into a corresponding one of the second apertures, and
the light sources in the second array of light sources are positioned so as to emit light towards the second apertures when caused to emit light.

15. The apparatus of claim 1, wherein there are four optically transmissive fins.

16. The apparatus of claim 1, wherein, when viewed along a first axis perpendicular to one of the side surfaces, the optically transmissive fins all at least partially overlap one other.

17. The apparatus of claim 16, wherein, when viewed along the first axis, the second longitudinal edge surfaces of at least two of the optically transmissive fins cross over one another at multiple first locations and do not cross over one another at second locations in between the first locations.

18. The apparatus of claim 1, further comprising an electronic gaming machine cabinet, wherein the base extends along at least one edge of the electronic gaming machine cabinet.
